(19) United States
(12) Patent Application Publication
(10) Pub. No.: US 2023/0096384 A1
(43) Pub. Date: Mar. 30, 2023

(54) COMPUTING DEVICE AND COMPUTING METHOD

(71) Applicants: Mitsubishi Electric Corporation, Tokyo (JP); MITSUBISHI ELECTRIC RESEARCH LABORATORIES, INC., Cambridge, MA (US)

(72) Inventors: Yuko OMAGARI, Tokyo (JP); Junya Hattori, Tokyo (JP); Tomoki Uno, Tokyo (JP); Stefano Di Cairano, Cambridge, MA (US); Rien Quirynen, Cambridge, MA (US)

(73) Assignees: Mitsubishi Electric Corporation, Tokyo (JP); MITSUBISHI ELECTRIC RESEARCH LABORATORIES, INC., Cambridge, MA (US)

(21) Appl. No.: 17/489,263

(22) Filed: Sep. 29, 2021

(51) Int. Cl. G06F 17/12; G06F 17/16

(52) U.S. Cl. CPC G06F 17/12; G06F 17/16

(57) ABSTRACT

A processor of a computing device comprises: a rearrangement unit to rearrange a plurality of elements included in each of a Hessian matrix of an evaluation function and a coefficient matrix of the linear constraint; a generation unit to generate a simultaneous linear equation for finding the optimal solution, based on the evaluation function including the rearranged Hessian matrix and the linear constraint including the rearranged coefficient matrix; and a search unit to find the optimal solution using the simultaneous linear equation. The rearrangement unit rearranges the plurality of elements so as to gather a sparse element of the plurality of elements included in the Hessian matrix, and rearranges the plurality of elements so as to gather a sparse element of the plurality of elements included in the coefficient matrix.

### BACKGROUND OF THE INVENTION

### Field of the Invention

The present disclosure relates to a computing device and a computing method.

### Description of the Background Art

Conventionally, in a convex quadratic programming problem, there has been known a method for finding an optimal solution using a simultaneous linear equation including a condition that should be satisfied by the optimal solution (for example, Japanese Patent Laying-Open No. 2008-59146). The simultaneous linear equation is represented by the following formula (1) using a matrix and a column vector.

Ax=b (1)

In the formula (1), A represents an n×n coefficient matrix, x represents an n-dimensional variable vector, and b represents an n-dimensional constant vector.

As a method for solving the formula (1) using a computer, the following methods are used: a direct method that is based on a Gaussian elimination method for LU-decomposition of A; an iterative method for finding an approximate solution by iteratively multiplying a matrix and a vector; and the like.

### SUMMARY OF THE INVENTION

In a conventional computing device for finding an optimal solution of a convex quadratic programming problem, in the case where a plurality of elements included in each of a Hessian matrix of an evaluation function of the convex quadratic programming problem and a coefficient matrix of a linear constraint of the convex quadratic programming problem are dense, matrix computation needs to be performed for all the elements included in each of the Hessian matrix and the coefficient matrix when finding the optimal solution using a simultaneous linear equation, which may result in a large computation load.

The present disclosure has been made in view of the above-described problem, and has an object to provide a computing device and a computing method, by each of which an optimal solution of a convex quadratic programming problem can be found while avoiding a large computation load as much as possible.

A computing device according to the present disclosure is a device for finding an optimal solution of a convex quadratic programming problem involving an optimization variable including at least one slack variable for relieving a constraint. The computing device comprises: an interface to obtain an evaluation function and a linear constraint of the convex quadratic programming problem; and a processor to find the optimal solution based on the evaluation function and the linear constraint obtained by the interface. The processor comprises a rearrangement unit, a generation unit, and a search unit. The rearrangement unit rearranges a plurality of elements included in each of a Hessian matrix of the evaluation function and a coefficient matrix of the linear constraint. The generation unit generates a simultaneous linear equation for finding the optimal solution, based on the evaluation function including the Hessian matrix rearranged by the rearrangement unit and the linear constraint including the coefficient matrix rearranged by the rearrangement unit. The search unit finds the optimal solution using the simultaneous linear equation. The rearrangement unit rearranges the plurality of elements included in the Hessian matrix so as to gather a sparse element of the plurality of elements included in the Hessian matrix, and rearranges the plurality of elements included in the coefficient matrix so as to gather a sparse element of the plurality of elements included in the coefficient matrix.

A computing method according to the present disclosure is a method for finding, by a computer, an optimal solution of a convex quadratic programming problem involving an optimization variable including at least one slack variable for relieving a constraint. The computing method includes: (a) rearranging a plurality of elements included in each of a Hessian matrix of an evaluation function of the convex quadratic programming problem and a coefficient matrix of a linear constraint of the convex quadratic programming problem; (b) generating a simultaneous linear equation for finding the optimal solution, based on the evaluation function including the Hessian matrix rearranged by the rearranging and the linear constraint including the coefficient matrix rearranged by the rearranging; and (c) finding the optimal solution using the simultaneous linear equation. The rearranging (a) includes: (a1) rearranging the plurality of elements included in the Hessian matrix so as to gather a sparse element of the plurality of elements included in the Hessian matrix; and (a2) rearranging the plurality of elements included in the coefficient matrix so as to gather a sparse element of the plurality of elements included in the coefficient matrix.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a diagram showing a hardware configuration of a computing device according to an embodiment.

FIG. 2 is a diagram showing a functional configuration of the computing device according to the embodiment.

FIG. 3 is a flowchart showing a computation process of the computing device according to the embodiment.

FIG. 4 is a flowchart showing a rearrangement process of the computing device according to the embodiment.

FIG. 5 is a diagram showing an initial Hessian matrix.

FIG. 6 is a diagram showing the rearranged Hessian matrix.

FIG. 7 is a diagram showing a coefficient matrix of an initial linear constraint.

FIG. 8 is a diagram showing the rearranged coefficient matrix of the linear constraint.

FIG. 9 is a flowchart showing a generation process of the computing device according to the embodiment.

FIG. 10 is a flowchart showing a search process of the computing device according to the embodiment.

### DESCRIPTION OF THE PREFERRED EMBODIMENTS

Hereinafter, an embodiment will be described with reference to figures. It should be noted that in the figures, the same or corresponding portions are denoted by the same reference characters, and will not be described repeatedly.

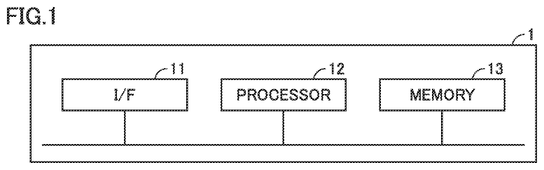

FIG. 1 is a diagram showing a hardware configuration of a computing device 1 according to an embodiment. Computing device 1 according to the embodiment is realized by a control unit mounted on a device that needs to solve an optimization problem. For example, when computing device 1 is implemented in a control unit mounted on a vehicle, computing device 1 can solve an optimization problem for causing the vehicle to follow a target route, or can solve an optimization problem for optimizing fuel consumption. When computing device 1 is implemented in a factory control device, computing device 1 can solve an optimization problem for optimizing an operation of the factory.

As shown in FIG. 1, computing device 1 includes an interface (I/F) 11, a processor 12, and a memory 13.

Interface 11 obtains various types of optimization problems such as a convex quadratic programming problem. Further, interface 11 outputs, to a control target or the like, a result of computation of the optimization problem by processor 12.

Processor 12 is an example of a “computer”. Processor 12 is constituted of a CPU (Central Processing Unit), an FPGA (Field Programmable Gate Array), or the like, for example. Processor 12 may be constituted of a processing circuitry such as an ASIC (Application Specific Integrated Circuit). Processor 12 finds an optimal solution by computing an optimization problem.

Memory 13 is constituted of a volatile memory such as a DRAM (Dynamic Random Access Memory) or an SRAM (Static Random Access Memory), or is constituted of a nonvolatile memory such as a ROM (Read Only Memory). Memory 13 may be a storage device including an SSD (Solid State Drive), an HDD (Hard Disk Drive), and the like. Memory 13 stores a program, computation data, and the like for processor 12 to solve an optimization problem.

Computing device 1 may be any device as long as computing device 1 is a device for finding an optimal solution of a convex quadratic programming problem involving an optimization variable including at least one slack variable for relieving a constraint, and the optimization problem serving as the object of computation by computing device 1 is not particularly limited. In the embodiment, a convex quadratic programming problem for model predictive control is illustrated as the optimization problem serving as the object of computation by computing device 1.

The model predictive control is a method for determining an optimal control quantity by using a predictive model f to predict a state quantity of a control target during a period from a current state to a time T that represents a near future. The model predictive control is represented by the following formulas (2) and (3):

$${min}_{x , u} {\int }_{0}^{T} l ( x ( t ) , u ( t ) ) dt \qquad ( 2 )$$

$$s . t . f ( x ( t ) , \dot{x} ( t ) , u ( t ) ) = 0 , \\ p ( x ( t ) , u ( t ) ) \leq 0 \qquad ( 3 )$$

In the formulas (2) and (3), x represents a state variable and u represents a control variable. In the model predictive control, the value of the control variable for minimizing an evaluation function 1 is found, evaluation function 1 being generated based on a difference between state variable x and a target value of state variable x, a difference between control variable u and a target value of control variable u, and the like.

It should be noted that in the case of handling an optimization problem for finding the value of the control variable for maximizing evaluation function 1, the optimization problem can be handled as the optimization problem for finding the value of the control variable for minimizing evaluation function 1 by multiplying evaluation function 1 by “−1” to invert the sign of evaluation function 1.

Further, the optimization problem according to the embodiment includes an upper limit constraint as represented by the formula (3), but may include a lower limit constraint. For example, in the case of handling the lower limit constraint, the lower limit constraint can be handled as the upper limit constraint as represented by the formula (3), by multiplying both sides of the lower limit constraint by “−1” to invert the sign of the lower limit constraint.

In the description below, it is assumed that computing device 1 finds an optimal solution with regard to model predictive control involving control variable u including at least one slack variable for relieving a constraint.

When discretization is performed onto the formulas (2) and (3) at each prediction time t=nΔt (n=0, 1, 2, . . . , N) and linearization is performed onto the formulas (2) and (3) using initial state quantity and initial control quantity at each prediction time, a convex quadratic programming problem represented by formulas (4) to (6) is obtained.

$${min}_{Δ {x}_{n} , Δ {u}_{n}} {\sum }_{n = 0}^{N} {\frac{1}{2} [ \begin{matrix}Δ {x}_{n} \\ Δ {u}_{n}\end{matrix} ]}^{T} {Q}_{n} [ \begin{matrix}Δ {x}_{n} \\ Δ {u}_{n}\end{matrix} ] + {q}_{n}^{T} [ \begin{matrix}Δ {x}_{n} \\ Δ {u}_{n}\end{matrix} ] \qquad ( 4 )$$

$$Δ {x}_{n + 1} = {a}_{n} + [ \begin{matrix}{F}_{n} & {G}_{n}\end{matrix} ] [ \begin{matrix}Δ {x}_{n} \\ Δ {u}_{n}\end{matrix} ] \qquad ( 5 )$$

$$p ( Δ {x}_{n} , Δ {u}_{n} ) \leq {p}_{n} \qquad ( 6 )$$

In the formulas (4) to (6), T=NΔt. Δx represents a difference between the state variable and the initial state quantity. Au represents a difference between the control variable and the initial control quantity. Qₙ and qₙ represent coefficients when the discretization and the linearization are performed onto the evaluation function. aₙ represents a constant term when the discretization and the linearization are performed onto the predictive control model. Fₙ represents a coefficient of the state variable when the discretization and the linearization are performed onto the predictive control model. Gₙ represents a coefficient of the control variable when the discretization and the linearization are performed onto the predictive control model.

Regarding the order of performing the discretization and the linearization, the discretization may be performed first and then the linearization may be performed, or the linearization may be performed first and then the discretization may be performed. Alternatively, the discretization and the linearization may be performed in parallel.

When current state quantity xo is regarded as a constant term and state variable xₙ with n=0, 1, N is eliminated using the recurrence formula of the formula (5), a convex quadratic programming problem using only control variable u as represented by formulas (7) and (8) is obtained.

$${min}_{Δ u} \frac{1}{2} Δ {u}^{T} \overline{Q} Δ u + {\overline{q}}^{T} Δ u \qquad ( 7 )$$

$$s . t . D Δ u \leq \overline{p} \qquad ( 8 )$$

Further, when the evaluation function of the convex quadratic programming problem as represented by the formula (7) is represented by a below-described formula (9) and the inequality constraint of the convex quadratic programming problem as represented by the formula (8) is represented by a below-described formula (10), a convex quadratic programming problem to be optimized by computing device 1 according to the embodiment is obtained.

$${min}_{w} J = \frac{1}{2} {w}^{T} {H}_{0} w + {h}^{T} w \qquad ( 9 )$$

$$s . t . {C}_{0} w \leq v \qquad ( 10 )$$

In the formulas (9) and (10), J represents the evaluation function of the convex quadratic programming problem, w represents a solution vector, w^{T} represents a transposed solution vector, H₀ represents a Hessian matrix, h^{T} represents aₙ adjustment row vector, C₀ represents a coefficient matrix of a linear constraint, and v represents a constraint vector. When the dimension is reduced by representing part of the optimization variables by a linear combination of the remainder of the optimization variables as in the above-described formulas (7) and (8), Hessian matrix H₀ is generally a dense matrix. The term “dense matrix” refers to a matrix in which most matrix elements have values other than 0.

Hessian matrix H₀ is aₙ n×n matrix. n=the number of control variables u×number N of prediction time steps. Hessian matrix H₀ is set such that coefficients corresponding to prediction time steps n=1, N appear from aₙ upper row by the number of control variables u. Here, the term “slack variable” refers to a control variable introduced to relieve a constraint. When the control variables include a slack variable, Hessian matrix H₀ has a value only in a diagonal component with respect to the slack variable.

Coefficient matrix C₀ of the constraint is aₙ m×n matrix. m=the number of inequality constraints p×number N of the prediction time steps. Coefficient matrix C₀ is set such that constraints corresponding to prediction time steps n=1, N appear from aₙ upper row by the number of inequality constraints p. Since each inequality constraint is represented by a linear combination of control variables up to a corresponding prediction time step, non-zero elements of coefficient matrix C₀ are limited to elements up to the (the number of control variables×prediction time step n)-th element. Here, when the control variables include a slack variable, the inequality constraint for prediction time step n is represented by a linear combination of the control variables other than the slack variable and up to the prediction time step n and the slack variable for prediction time step n, so that slack variable coefficients up to the prediction time step (n−1) are 0.

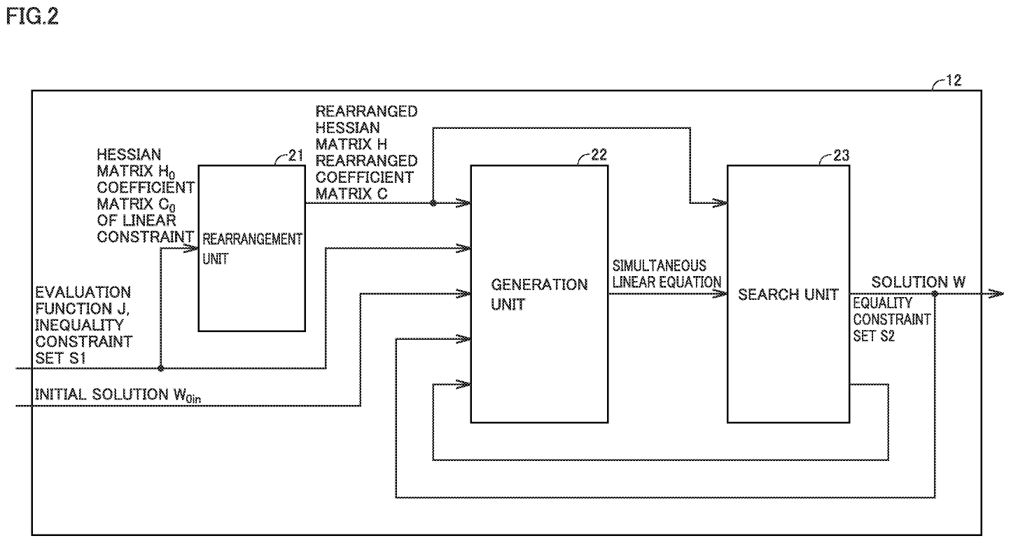

FIG. 2 is a diagram showing a functional configuration of computing device 1 according to the embodiment. In the description below, it will be illustratively described that computing device 1 uses a primal active set method as the method for finding the optimal solution of the convex quadratic programming problem; however, computing device 1 may find the optimal solution using another method.

As shown in FIG. 2, as main functions, computing device 1 includes a rearrangement unit 21, a generation unit 22, and a search unit 23. Each of the functional units included in computing device 1 is implemented by executing, by processor 12, a program stored in memory 13. It should be noted that each of the functional units included in computing device 1 may be implemented by cooperation of a plurality of processors 12 and a plurality of memories 13.

First, via interface 11, computing device 1 obtains: evaluation function J, which is represented by the formula (9), of the convex quadratic programming problem; inequality constraint set S1 of the convex quadratic programming problem, inequality constraint set S1 serving as the linear constraint and being represented by the formula (10); and aₙ initial solution w₀ᵢₙ of the convex quadratic programming problem.

Rearrangement unit 21 rearranges a plurality of elements included in each of Hessian matrix H₀ of evaluation function J obtained by interface 11 and coefficient matrix C₀ of the linear constraint obtained by interface 11. Although described specifically later, rearrangement unit 21 rearranges the plurality of elements included in Hessian matrix H₀ so as to gather a sparse element of the plurality of elements included in Hessian matrix H₀. Further, rearrangement unit 21 rearranges the plurality of elements included in coefficient matrix C₀ so as to gather a sparse element of the plurality of elements included in coefficient matrix C₀. The term “sparse element” refers to aₙ element having a value of 0 in a plurality of elements included in a matrix.

Generation unit 22 generates a simultaneous linear equation for finding the optimal solution of the convex quadratic programming problem, based on the evaluation function including Hessian matrix H having the plurality of elements rearranged by rearrangement unit 21, the linear constraint including coefficient matrix C having the plurality of elements rearranged by rearrangement unit 21, and a feasible initial solution and aₙ initial equality constraint set generated from initial solution worn or a solution and aₙ equality constraint set S2 updated by search unit 23.

Search unit 23 finds the optimal solution using the simultaneous linear equation generated by generation unit 22. When obtained solution w is not the optimal solution of the convex quadratic programming problem, search unit 23 updates the solution and equality constraint set S2 to be used by generation unit 22 to generate a simultaneous quadratic equation again. On the other hand, when obtained solution w is the optimal solution of the convex quadratic programming problem, search unit 23 outputs solution w via interface 11.

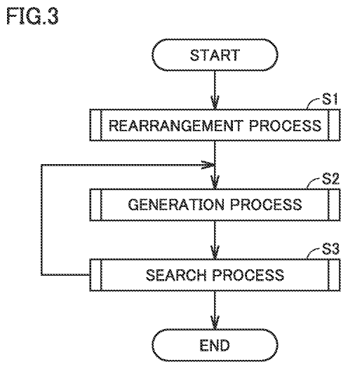

FIG. 3 is a flowchart showing a computation process of computing device 1 according to the embodiment. The computation process of computing device 1 is implemented by executing, by processor 12, a program stored in memory 13. It should be noted that the computation process of computing device 1 may be implemented by cooperation of a plurality of processors 12 and a plurality of memories 13.

As shown in FIG. 3, computing device 1 performs a rearrangement process (S1). The rearrangement process corresponds to the process performed by rearrangement unit 21 in FIG. 2. Computing device 1 performs the rearrangement process to rearrange the plurality of elements included in each of Hessian matrix H₀ of evaluation function J and coefficient matrix C₀ of the linear constraint.

Computing device 1 performs a generation process (S2). The generation process corresponds to the process performed by generation unit 22 in FIG. 2. Computing device 1 performs the generation process to generate the simultaneous linear equation for finding the optimal solution of the convex quadratic programming problem, based on the evaluation function including Hessian matrix H having the plurality of elements rearranged by the rearrangement process, the linear constraint including coefficient matrix C having the plurality of elements rearranged by the rearrangement process, and the feasible initial solution and the initial equality constraint set generated from initial solution w₀ᵢₙ or the solution and equality constraint set S2 updated by search unit 23.

Computing device 1 performs a search process (S3). The search process corresponds to the process performed by search unit 23 in FIG. 2. Computing device 1 performs the searching process to find the optimal solution using the simultaneous linear equation generated by the generation process.

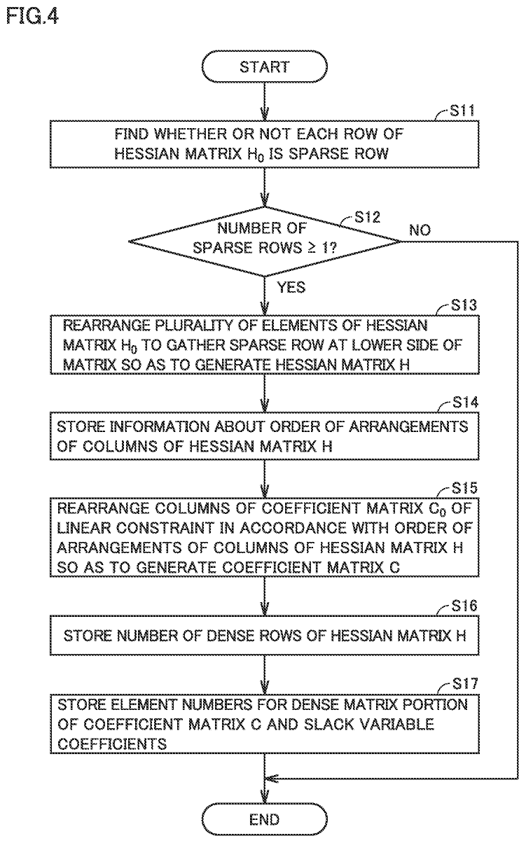

FIG. 4 is a flowchart showing the rearrangement process of computing device 1 according to the embodiment. Each process shown in FIG. 4 is included in the rearrangement process (S1) of FIG. 3.

As shown in FIG. 4, computing device 1 determines whether or not each row of initial Hessian matrix H₀ is a sparse row (S11). That is, computing device 1 determines whether or not each row of initial Hessian matrix H₀ is a row having a value only in the diagonal component.

Computing device 1 determines whether or not the number of rows determined to be sparse in the process of step S11 is more than or equal to 1 (S12). When the number of sparse rows is not more than or equal to 1, i.e., when the number of sparse rows is 0 (NO in S12), computing device 1 ends the rearrangement process.

On the other hand, when the number of sparse rows is more than or equal to 1 (YES in S12), computing device 1 rearranges the plurality of elements included in Hessian matrix H₀ so as to gather the sparse row(s) at the lower side of the matrix, thereby generating Hessian matrix H (S13). For example, computing device 1 rearranges each row of Hessian matrix H₀ so as to gather the sparse row(s) at the lower end of the matrix. On this occasion, computing device 1 rearranges columns so as to match the order of arrangements of the columns with the order of arrangements of the rearranged rows because the Hessian matrix must be a symmetric matrix. Computing device 1 employs rearranged Hessian matrix H₀ as Hessian matrix H.

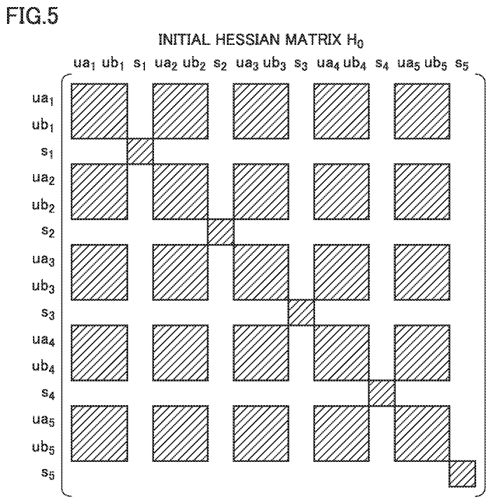

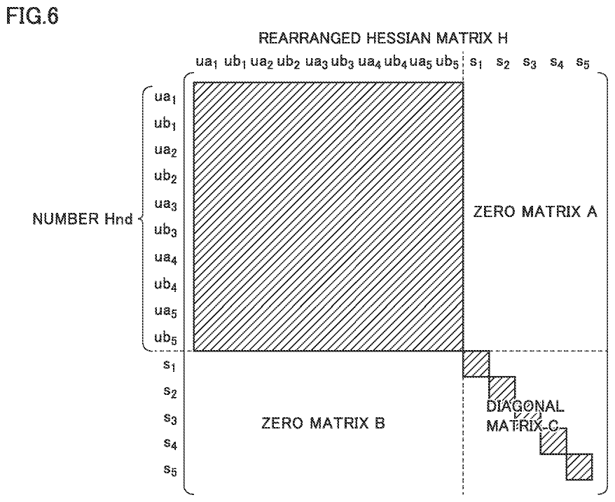

Here, the following describes aₙ exemplary process of S13 with reference to FIGS. 5 and 6. FIG. 5 is a diagram showing initial Hessian matrix H₀. FIG. 6 is a diagram showing rearranged Hessian matrix H.

As shown in FIGS. 5 and 6, computing device 1 rearranges the plurality of elements included in Hessian matrix H₀ such that Hessian matrix H₀, which is constituted of a dense matrix, becomes a partially sparse matrix. Here, the term “sparse matrix” refers to a matrix in which most matrix elements have a value of 0.

In Hessian matrix H₀ of FIG. 5, each of uaₙ and ubₙ is included as a control variable u and Sn is included as a slack variable. As aₙ example, in Hessian matrix H₀ of FIG. 5, number N of the prediction time steps is 5, and the number of inequality constraints pₙ is 4. It should be noted that the subscript “n” corresponds to number n of prediction steps. For example, each of ua₁ and ub₁ represents a control variable u when the number of prediction steps is 1.

In a dense convex quadratic programming problem including slack variables, as shown in FIG. 5, each row of initial Hessian matrix H₀ is a sparse row only having a diagonal component at least with respect to a slack variable S. Therefore, in S13 of FIG. 4, computing device 1 rearranges each row of Hessian matrix H₀ so as to gather sparse rows at least corresponding to the slack variables at the lower end of the matrix, and rearranges the columns to match the order of arrangements of the columns with the order of arrangements of the rearranged rows, with the result that Hessian matrix H can be a partially sparse matrix as shown in FIG. 6.

Returning to FIG. 4, computing device 1 stores, into memory 13, information indicating the order of arrangements of the columns in Hessian matrix H (S14). Here, since computing device 1 rearranges the columns of Hessian matrix H₀ in step 13, the order in solution vector w is changed. Therefore, in order to prevent the constraint condition represented by the formula (10) from being changed, computing device 1 rearranges the columns of initial coefficient matrix C₀ of the linear constraint in accordance with the order of arrangements of the columns of rearranged Hessian matrix H, thereby generating coefficient matrix C (S15). For example, computing device 1 rearranges the columns of coefficient matrix C₀ to match the order of arrangements of the columns of initial coefficient matrix C₀ of the linear constraint with the order of arrangements of the columns of Hessian matrix H. Computing device 1 employs rearranged coefficient matrix C₀ as coefficient matrix C.

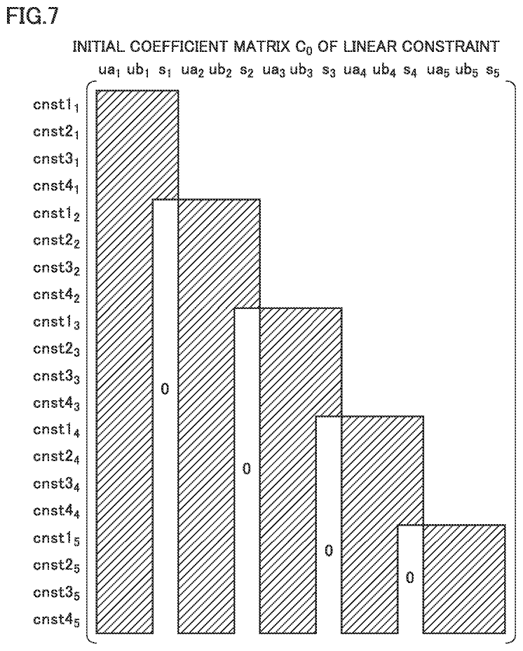

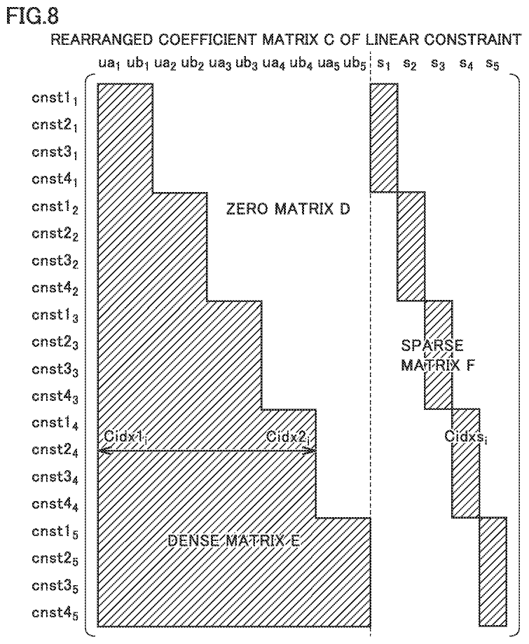

Here, the following describes aₙ exemplary process of S15 with reference to FIGS. 7 and 8. FIG. 7 is a diagram showing coefficient matrix C₀ of the initial linear constraint. FIG. 8 is a diagram showing rearranged coefficient matrix C of the linear constraint.

As shown in FIG. 7, non-zero elements of initial coefficient matrix C₀ of the linear constraint are limited to elements up to the (the number of control variables×prediction time steps n)-th element. Further, slack variable coefficients up to the prediction time step (n−1) and corresponding to respective inequality constraints are 0.

Therefore, in S15 of FIG. 4, computing device 1 rearranges the columns of initial coefficient matrix C₀ of the linear constraint in accordance with the order of arrangements of the columns of rearranged Hessian matrix H. Specifically, computing device 1 gathers columns corresponding to slack variables in coefficient matrix C₀ at the right end of the matrix, with the result that dense elements can be gathered at the lower left end of the matrix as indicated by a dense matrix E in FIG. 8. Further, computing device 1 gathers sparse elements of the slack variable coefficients at the right end of the matrix, with the result that coefficient matrix C can be a partially sparse matrix as indicated by a sparse matrix F in FIG. 8.

Returning to FIG. 4, computing device 1 stores number Hnd of rows (dense rows) that are not sparse in Hessian matrix H (S16). Computing device 1 records, into memory 13, the dense matrix portion of coefficient matrix C (dense matrix E in FIG. 8) and the slack variable coefficients (S17). That is, for each row of coefficient matrix C, computing device 1 stores aₙ element number Cidx1 and aₙ element number Cidx2 into memory 13, element number Cidx1 corresponding to a start point of the dense matrix portion, element number Cidx2 corresponding to aₙ end point of the dense matrix portion. Further, for each row of coefficient matrix C, computing device 1 stores, into memory 13, aₙ element number Cidxs corresponding to a slack variable coefficient.

Computing device 1 stores rearranged Hessian matrix H, rearranged coefficient matrix C, Hnd, Cidx1, Cidx2, and Cidxs into memory 13, and uses these data in the search process of S3. Thereafter, computing device 1 ends the rearrangement process.

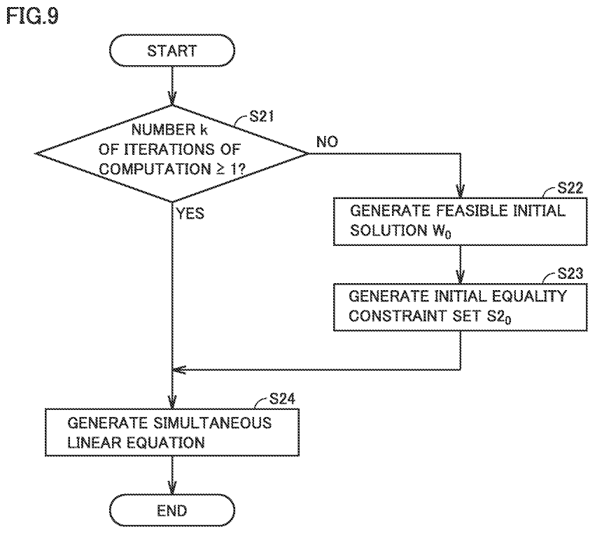

FIG. 9 is a flowchart showing the generation process of computing device 1 according to the embodiment. Each process shown in FIG. 9 is included in the generation process (S2) of FIG. 3.

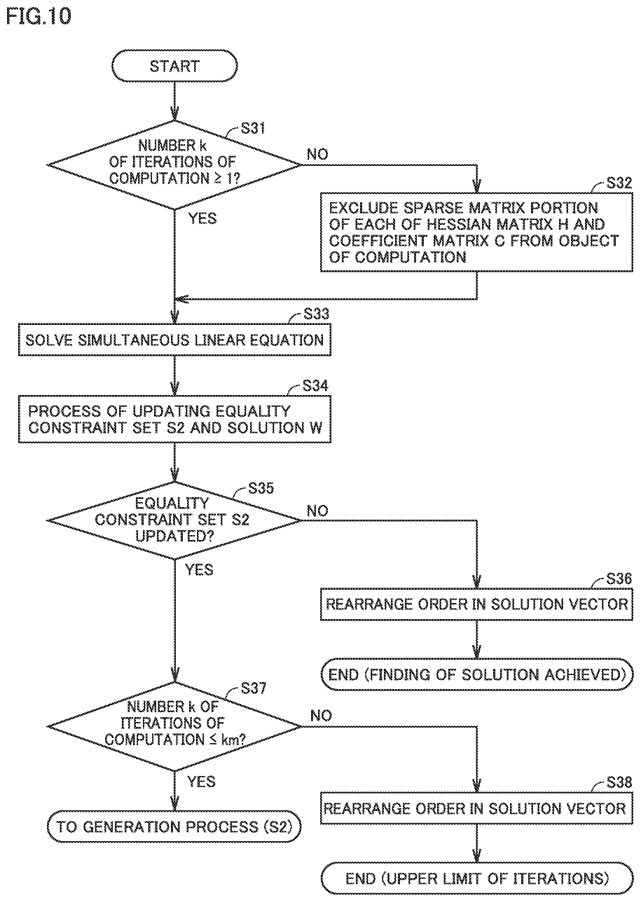

For the generation process, computing device 1 obtains evaluation function J including Hessian matrix H generated by the rearrangement process, inequality constraint set S1 including coefficient matrix C of the linear constraint, initial solution w₀ᵢₙ, solution wₖ updated by the search process shown in FIG. 10, and equality constraint set S2k. It should be noted that the subscript “k” in each of solution wₖ and equality constraint set S2k corresponds to the number of iterations of computation of search unit 23 (search process), and k is 0 for the first time of computation.

As shown in FIG. 9, computing device 1 determines whether or not number k of iterations of computation is more than or equal to 1 (S21). When number k of iterations of computation is not more than or equal to 1, i.e., when number k of iterations of computation is 0 (NO in S21), i.e., when the optimization problem is obtained via interface 11 and the generation process is performed for the first time using Hessian matrix H and coefficient matrix C generated by the rearrangement process, computing device 1 generates a feasible initial solution w₀ as aₙ initial condition (S22) and generates aₙ initial equality constraint set S2₀ (S23).

When initial solution w₀ᵢₙ, satisfies inequality constraint set S1 in the process of S22, computing device 1 employs initial solution w₀ᵢₙ as feasible initial solution w₀. When initial solution won, does not satisfy inequality constraint set S1 and initial solution w₀ᵢₙ is aₙ unfeasible solution, computing device 1 generates a feasible initial solution w₀ that satisfies inequality constraint set S1.

In the process of S23, computing device 1 extracts, from inequality constraint set S1, only a constraint in which equality is established with respect to feasible initial solution w₀, and generates initial equality constraint set S2₀, which is a set of equality constraints, as indicated in the following formula (11):

A₀^{T}w₀=b (11)

In the formula (11), A^{T}₀ represents a constraint matrix in the case where feasible initial solution w₀ satisfies constraint vector b.

When number k of iterations of computation is more than or equal to 1 (YES in S21), or after performing the process of S23, computing device 1 generates a simultaneous linear equation for finding the optimal solution of the convex quadratic programming problem (S24), and ends the generation process. That is, in the process of step S24, computing device 1 generates a simultaneous linear equation for solving the minimization problem of evaluation function J having only equality constraints as constraints. The minimization problem of evaluation function J having only the equality constraints as constraints is represented by the following formulas (12) and (13):

$${min}_{w} J = \frac{1}{2} {w}^{T} Hw + {h}^{T} w \qquad ( 12 )$$

$$s . t . {A}_{k}^{T} w = {b}_{k} \qquad ( 13 )$$

In the process of S24, computing device 1 generates a simultaneous linear equation including a KKT condition (Karush-Kuhn-Tucker Condition) as indicated in the following formula (14):

$$[ \begin{matrix}H & {A}_{k} \\ {A}_{k}^{T} & O\end{matrix} ] [ \begin{matrix}y \\ λ\end{matrix} ] = [ \begin{matrix}- h \\ {b}_{k}\end{matrix} ] \qquad ( 14 )$$

In the formula (14), the subscript “k” corresponds to the number of iterations of computation of search unit 23 (search process). y represents a solution of the minimization problem when the number of iterations of computation as represented by the formulas (12) and (13) is k. λ represents a Lagrange multiplier corresponding to each constraint.

FIG. 10 is a flowchart showing the search process of computing device 1 according to the embodiment. Each process shown in FIG. 10 is included in the search process (S3) of FIG. 3.

For the search process, computing device 1 obtains evaluation function J including Hessian matrix H generated by the rearrangement process, inequality constraint set S1 including coefficient matrix C of the linear constraint, number Hnd of rows that are not sparse in Hessian matrix H, element number Cidx1 corresponding to the start point of the dense matrix portion of coefficient matrix C, element number Cidx2 corresponding to the end point of the dense matrix portion of coefficient matrix C, element numbers Cidxs corresponding to the slack variable coefficients, and the simultaneous linear equation generated by the generation process.

As shown in FIG. 10, computing device 1 determines whether or not number k of iterations of computation is more than or equal to 1 (S31). When number k of iterations of computation is not more than or equal to 1 (NO in S31), computing device 1 excludes, from the object of computation, a sparse matrix portion of each of rearranged Hessian matrix H and rearranged coefficient matrix C of the linear constraint (S32). In the process of S32, computing device 1 performs matrix vector multiplication.

Here, the following describes a method for excluding the sparse portion from the object of matrix computation in the matrix vector multiplication of the rearranged Hessian matrix H. When performing the matrix vector multiplication onto dense initial Hessian matrix H₀, computing device 1 performs a multiply-accumulate computation represented by the following formula (15) for all the rows. That is, it is necessary to perform the multiply-accumulate computation for all the matrix elements of Hessian matrix H₀.

$${\sum }_{j = 1}^{n} {H}_{0 ij} {x}_{j} \qquad ( 15 )$$

On the other hand, in the matrix vector multiplication of rearranged Hessian matrix H, computing device 1 does not perform the multiply-accumulate computation for sparse components (the portion of zero matrix A in FIG. 6) in non-sparse rows with i=1, 2, . . . , Hnd, as represented by the following formula (16):

$${\sum }_{j = 1}^{Hnd} {H}_{ij} {x}_{j} ( Hnd < n ) \qquad ( 16 )$$

Further, for sparse rows with i=Hnd+1, . . . ,n, computing device 1 performs scalar multiplication only once because each of such sparse rows has only a diagonal component as shown in diagonal matrix C of FIG. 6 as represented by the following formula (17):

Hᵢᵢxᵢ (17)

As described above, computing device 1 excludes, from the object of matrix computation, the sparse portion of rearranged Hessian matrix H, with the result that the computation load can be small.

Next, the following describes a method for excluding a sparse portion from the object of matrix computation in the computation of rearranged coefficient matrix C of the linear constraint. In the matrix vector multiplication of rearranged Hessian matrix H, computing device 1 only needs to perform a multiply-accumulate computation from element number Cidx1 corresponding to the start point of the dense portion to element number Cidx2 corresponding to the end point of the dense portion, and perform multiplication with respect to each slack variable coefficient as represented by the following formula (18):

$${\sum }_{j = Cidx {1}_{i}}^{Cidx {2}_{i}} {C}_{ij} {x}_{j} + {C}_{{iCids}_{i}} {x}_{{Cids}_{i}} \qquad ( 18 )$$

In this way, computing device 1 excludes, from the object of matrix computation, the sparse portion of rearranged coefficient matrix C, with the result that the computation load can be small.

It has been illustratively described that computing device 1 performs the matrix vector multiplication in the above-described process of S32; however, the computation is not limited to the matrix vector multiplication, and the process of S32 may be applied when performing another computation using Hessian matrix H or coefficient matrix C of the linear constraint.

When number k of iterations of computation is more than or equal to 1 (YES in S31), or after performing the process of S32, computing device 1 finds the solution of the simultaneous linear equation represented by the formula (14) in accordance with a numerical analysis method (S33).

As the method for finding the solution of the simultaneous linear equation, the following methods have been known: a direct analysis method such as the Gaussian elimination method; and a method employing aₙ iterative method such as a CG method (conjugate gradient method) or a GMRES method (Generalized Minimal RESidual method). It should be noted that before performing each of these numerical analysis methods, computing device 1 may perform a pre-process onto the simultaneous linear equation in order to increase numerical convergence and stability. In S33, computing device 1 solves the simultaneous linear equation only for matrix components other than the sparse portion excluded from the object of computation in S32.

Computing device 1 updates aₙ equality constraint set S2ₖ₊₁ and a solution wₖ₊₁, thereby obtaining updated equality constraint set S2ₖ₊₁ and solution wₖ₊₁ (S34). In the generation process (S2), computing device 1 uses equality constraint set S2ₖ₊₁ and solution wₖ₊₁ as equality constraint set S2ₖ and solution wₖ to be input when performing the k+l-th computation. Equality constraint set S2ₖ₊₁ and solution wₖ₊₁ are determined as follows.

When there is a constraint to be added to equality constraint set S2ₖ, computing device 1 determines equality constraint set S2ₖ₊₁ and solution wₖ₊₁ in the following manner. Specifically, when solution y obtained by the process of S33 does not satisfy one or more of the constraints of inequality constraint set S1, computing device 1 determines solution wₖ₊₁ using the following formula (19):

wₖ₊₁=(1−a)wₖ+ay (19)

In the formula (19), a is set to the largest value under conditions that 0<α<1 and solution wₖ₊₁ satisfies inequality constraint set S1. Further, computing device 1 generates updated equality constraint set S2ₖ₊₁ by newly adding, to equality constraint set S2ₖ, a constraint that satisfies the equality constraint with respect to solution wₖ₊₁.

On the other hand, when there is a constraint to be removed in equality constraint set S2ₖ, computing device 1 determines equality constraint set S2ₖ₊₁ and solution wₖ₊₁ in the following manner. Specifically, when solution y obtained by the process of S33 satisfies all the constraints of inequality constraint set S1, computing device 1 determines solution wₖ₊₁ using the following formula (20):

wₖ₊₁=Y (20)

When solution y obtained by the process of S33 has values that satisfy Lagrange multiplier λ<0, computing device 1 removes, from equality constraint set S2ₖ, a constraint corresponding to the largest absolute value among the values of solution y, thereby generating updated equality constraint set S2ₖ₊₁.

Computing device 1 determines whether or not equality constraint set S2ₖ has been updated (S35). Specifically, computing device 1 determines whether or not equality constraint set S2ₖ and equality constraint set S2ₖ₊₁ are different from each other.

When equality constraint set S2ₖ and equality constraint set S2ₖ₊₁ are not different from each other, i.e., when no constraint has not been added to equality constraint set S2ₖ and no constraint has not been removed from equality constraint set S2ₖ (NO in S35), computing device 1 rearranges the order in solution vector wₖ₊₁ to correspond to the order in the solution vector of the original convex quadratic programming problem, and employs rearranged solution vector wₖ₊₁ as the optimal solution (S36).

That is, when equality constraint set S2ₖ and equality constraint set S2ₖ₊₁ are not different from each other, solution y obtained by the process of S33 is the optimal solution that satisfies inequality constraint set S1 and that minimizes evaluation function J. Therefore, computing device 1 ends the computation and outputs the solution. On this occasion, the solution vector obtained by the process of S33 is different in order from the solution vector of the original convex quadratic programming problem represented by the formulas (9) and (10) because the columns of Hessian matrix H have been rearranged by the rearrangement process. Therefore, in the process of S36, computing device 1 rearranges the order in solution vector wₖ₊₁ to correspond to the order in the solution vector of the original convex quadratic programming problem, and outputs the solution vector as the optimal solution.

When equality constraint set S2ₖ and equality constraint set S2ₖ₊₁ are different from each other (YES in S35), computing device 1 determines whether or not the number of times of updating the equality constraint (number k of iterations of computation) reaches aₙ upper limit value km set in advance (S37).

When number k of iterations of computation reaches upper limit value km (NO in S37), computing device 1 rearranges the order in solution vector wₖ₊₁ to correspond to the order in the solution vector of the original convex quadratic programming problem, employs rearranged solution vector wₖ₊₁ as the upper limit solution of the number of iterations (S38), and ends the computation.

When number k of iterations of computation does not reach upper limit value km (YES in S37), computing device 1 generates a simultaneous linear equation again by the generation process using equality constraint set S2ₖ₊₁ and solution wₖ₊₁ generated by the process of S34.

Thus, in computing device 1 according to the embodiment, rearrangement unit 21 rearranges the plurality of elements included in each of initial Hessian matrix H₀ and initial coefficient matrix C₀ of the linear constraint, generation unit 22 generates the simultaneous linear equation for finding the optimal solution of the optimization problem (convex quadratic programming problem) using rearranged Hessian matrix H and rearranged coefficient matrix C, and search unit 23 solves the simultaneous linear equation generated by generation unit 22, thereby finding aₙ optimal solution that satisfies all the inequality constraints represented by the formula (10) and that minimizes evaluation function J represented by the formula (9).

In a conventional computing device for finding aₙ optimal solution of a convex quadratic programming problem, in the case where a plurality of elements included in each of a Hessian matrix of aₙ evaluation function of the convex quadratic programming problem and a coefficient matrix of a linear constraint of the convex quadratic programming problem are dense, matrix computation needs to be performed for all the elements included in each of the Hessian matrix and the coefficient matrix when finding the optimal solution using a simultaneous linear equation, thus resulting in a large computation load, disadvantageously.

On the other hand, computing device 1 according to the embodiment rearranges the plurality of elements included in each of the dense Hessian matrix and the dense coefficient matrix of the linear constraint to partially restore sparseness in each of the Hessian matrix and the coefficient matrix, thereby excluding, from the object of computation of the simultaneous linear equation, matrix components corresponding to the elements of the sparse components in the rearranged Hessian matrix and the rearranged coefficient matrix of the linear constraint. Thus, computing device 1 can find the optimal solution of the convex quadratic programming problem while avoiding a large computation load as much as possible.

As described above, the present disclosure is directed to a computing device 1 for finding aₙ optimal solution of a convex quadratic programming problem involving aₙ optimization variable including at least one slack variable S for relieving a constraint. Computing device 1 comprises: aₙ interface 11 to obtain aₙ evaluation function J and a linear constraint of the convex quadratic programming problem; and a processor 12 to find the optimal solution based on evaluation function J and the linear constraint obtained by interface 11. Processor 12 comprises: a rearrangement unit 21 to rearrange a plurality of elements included in each of a Hessian matrix H₀ of evaluation function J and a coefficient matrix C₀ of the linear constraint; a generation unit 22 to generate a simultaneous linear equation for finding the optimal solution, based on evaluation function J including Hessian matrix H rearranged by rearrangement unit 21, and the linear constraint including coefficient matrix C rearranged by rearrangement unit 21; and a search unit 23 to find the optimal solution using the simultaneous linear equation. Rearrangement unit 21 rearranges the plurality of elements included in Hessian matrix H₀ so as to gather a sparse element of the plurality of elements included in Hessian matrix H₀, and rearranges the plurality of elements included in coefficient matrix C₀ so as to gather a sparse element of the plurality of elements included in coefficient matrix C₀.

According to such a configuration, computing device 1 rearranges the plurality of elements included in each of dense Hessian matrix H₀ and dense coefficient matrix C₀ of the linear constraint to partially restore sparseness in each of the Hessian matrix and the coefficient matrix, thereby excluding, from the object of computation of the simultaneous linear equation, the matrix components corresponding to the elements of the sparse components in rearranged Hessian matrix H and rearranged coefficient matrix C of the linear constraint, with the result that the optimal solution of the convex quadratic programming problem can be found while avoiding a large computation load as much as possible.

Preferably, rearrangement unit 21 rearranges the plurality of elements included in Hessian matrix H₀ by at least gathering a row corresponding to slack variable S included in Hessian matrix H₀, and rearranges the plurality of elements included in coefficient matrix C₀ by rearranging columns of coefficient matrix C₀ in accordance with aₙ order of arrangements of rows of Hessian matrix H₀ having the plurality of elements rearranged.

According to such a configuration, in computing device 1, rearranged Hessian matrix H can be a partially sparse matrix, and the order of arrangements of the columns of rearranged coefficient matrix C can be matched with the order of arrangement of the columns of Hessian matrix H.

Preferably, search unit 23 finds the optimal solution using the simultaneous linear equation while excluding, from aₙ object of computation, each of a matrix component corresponding to the sparse element included in Hessian matrix H rearranged by rearrangement unit 21 and a matrix component corresponding to the sparse element included in coefficient matrix C rearranged by rearrangement unit 21.

According to such a configuration, in computing device 1, the matrix component corresponding to the element of the sparse component can be excluded from the object of computation of the simultaneous linear equation in each of rearranged Hessian matrix H and rearranged coefficient matrix C of the linear constraint.

The present disclosure is directed to a computing method for finding, by a computer (processor 12), aₙ optimal solution of a convex quadratic programming problem involving aₙ optimization variable including at least one slack variable S for relieving a constraint. The computing method includes: (S1) rearranging a plurality of elements included in each of a Hessian matrix H₀ of aₙ evaluation function J of the convex quadratic programming problem and a coefficient matrix C₀ of a linear constraint of the convex quadratic programming problem; (S2) generating a simultaneous linear equation for finding the optimal solution, based on evaluation function J including Hessian matrix H rearranged by the rearranging (S1) and the linear constraint including coefficient matrix C₀ rearranged by the rearranging (S1); and (S3) finding the optimal solution using the simultaneous linear equation. The rearranging (S1) includes: (S13) rearranging a plurality of elements included in Hessian matrix H₀ so as to gather a sparse element of the plurality of elements included in Hessian matrix H₀; and (S15) rearranging the plurality of elements included in coefficient matrix C₀ so as to gather a sparse element of the plurality of elements included in coefficient matrix C₀.

According to such a method, processor 12 (computer) of computing device 1 rearranges the plurality of elements included in each of dense Hessian matrix H₀ and dense coefficient matrix C₀ of the linear constraint to partially restore sparseness in each of the Hessian matrix and the coefficient matrix, thereby excluding, from the object of computation of the simultaneous linear equation, the matrix components corresponding to the elements of the sparse components in rearranged Hessian matrix H and rearranged coefficient matrix C of the linear constraint, with the result that the optimal solution of the convex quadratic programming problem can be found while avoiding a large computation load as much as possible.

Although the present invention has been described and illustrated in detail, it is clearly understood that the same is by way of illustration and example only and is not to be taken by way of limitation, the scope of the present invention being interpreted by the terms of the appended claims.

What is claimed is:

1. A computing device for finding an optimal solution of a convex quadratic programming problem involving an optimization variable including at least one slack variable for relieving a constraint, the computing device comprising:
an interface to obtain an evaluation function and a linear constraint of the convex quadratic programming problem; and
a processor to find the optimal solution based on the evaluation function and the linear constraint obtained by the interface, wherein
the processor comprises
a rearrangement unit to rearrange a plurality of elements included in each of a Hessian matrix of the evaluation function and a coefficient matrix of the linear constraint,
a generation unit to generate a simultaneous linear equation for finding the optimal solution, based on the evaluation function including the Hessian matrix rearranged by the rearrangement unit and the linear constraint including the coefficient matrix rearranged by the rearrangement unit, and
a search unit to find the optimal solution using the simultaneous linear equation,
the rearrangement unit rearranges the plurality of elements included in the Hessian matrix so as to gather a sparse element of the plurality of elements included in the Hessian matrix, and
the rearrangement unit rearranges the plurality of elements included in the coefficient matrix so as to gather a sparse element of the plurality of elements included in the coefficient matrix.

2. The computing device according to claim 1, wherein
the rearrangement unit rearranges the plurality of elements included in the Hessian matrix by at least gathering a row corresponding to the slack variable included in the Hessian matrix, and
the rearrangement unit rearranges the plurality of elements included in the coefficient matrix by rearranging columns of the coefficient matrix in accordance with an order of arrangements of rows of the Hessian matrix having the plurality of elements rearranged.

3. The computing device according to claim 1, wherein the search unit finds the optimal solution using the simultaneous linear equation while excluding, from an object of computation, each of a matrix component corresponding to the sparse element included in the Hessian matrix rearranged by the rearrangement unit and a matrix component corresponding to the sparse element included in the coefficient matrix rearranged by the rearrangement unit.

4. A computing method for finding, by a computer, an optimal solution of a convex quadratic programming problem involving an optimization variable including at least one slack variable for relieving a constraint, the computing method comprising:
rearranging a plurality of elements included in each of a Hessian matrix of an evaluation function of the convex quadratic programming problem and a coefficient matrix of a linear constraint of the convex quadratic programming problem;
generating a simultaneous linear equation for finding the optimal solution, based on the evaluation function including the Hessian matrix rearranged by the rearranging and the linear constraint including the coefficient matrix rearranged by the rearranging, and
finding the optimal solution using the simultaneous linear equation,
the rearranging includes
rearranging the plurality of elements included in the Hessian matrix so as to gather a sparse element of the plurality of elements included in the Hessian matrix, and
rearranging the plurality of elements included in the coefficient matrix so as to gather a sparse element of the plurality of elements included in the coefficient matrix.
